(19) United States
(12) Patent Application Publication
(10) Pub. No.: US 2026/0024082 A1
(43) Pub. Date: Jan. 22, 2026

(54) SYSTEMS AND METHODS FOR USE IN INTELLIGENT BINDING BASED ON NETWORK TRANSACTIONS

(71) Applicant: MASTERCARD INTERNATIONAL INCORPORATED, PURCHASE, NY (US)

(72) Inventors: Mohammad Mehdi Kafashan, Wildwood, MO (US); Wally F. Lo Faro, St. Louis, MO (US)

(21) Appl. No.: 18/775,844

(22) Filed: Jul. 17, 2024

(51) Int. Cl. G06Q 20/40; G06Q 20/34

(52) U.S. Cl. CPC G06Q 20/401; G06Q 20/347

(57) ABSTRACT

Systems and methods are provided for binding parties based on network transactions. One example method includes receiving an authorization request for a transaction to an account, the authorization request including data specific to a vendor party; matching the authorization request to a pre-authorization request, the pre-authorization request including an initiator party; matching the initiator party and the vendor party, as a pair, to one of multiple initiator/vendor party pairs in a data structure; appending, to the authorization request, an indicator of the match between the initiator party and the vendor party, and the one of multiple initiator/vendor party pairs in the data structure; and forwarding the authorization request with the indicator to an issuer associated with the account.

### FIELD

The present disclosure generally relates to systems and methods for use in intelligent binding between parties, based on historical network transactions.

### BACKGROUND

This section provides background information related to the present disclosure which is not necessarily prior art.

Network traffic is representative of network interactions between two or more parties. The network interaction may include payment transactions, in which the network traffic is representative of authorization of the transactions, and then, potentially, clearing and settlement of the transactions. The network traffic generally includes data that permits the payment transactions to be identified to specific accounts, financial institutions, etc. In conventional four-party transactions, for example, a first party receives a payment credential (i.e., specific to an account of a user) from the user and submits an authorization request, which is routed, through a processing network, to an issuer of the account being used. As appropriate, the issuer authorizes the transaction via messaging through the processing network, and the transaction is later cleared and settled between the first party and the issuer, through intermediate banks and processing networks, etc. More recently, in e-commerce transactions, secure remote commerce (SRC) is available, whereby the user is permitted to enroll an account issued by the issuer, and then “click to pay” at one or more first parties to streamline checkout. In such transactions, the authorization is based on a token specific to the account.

In some instances, where a transaction amount is not yet known, yet authorization is required, a pre-authorization request is submitted by the first party, via the processing network, to the issuer, whereby there is a pre-authorization, by the issuer, for the first party to charge up to a specified amount to the user's account. After the pre-authorization is issued, the first party then, within an interval, submits the authorization request tied to the pre-authorization, and the transaction proceeds, as above.

### DRAWINGS

The drawings described herein are for illustrative purposes only of selected embodiments and not all possible implementations, and are not intended to limit the scope of the present disclosure.

FIG. 1 illustrates an example system of the present disclosure suitable for use in binding parties, between pre-authorization and authorization, based on network transactions;

FIG. 2 is a block diagram of an example computing device that may be used in the system of FIG. 1;

FIG. 3 is an example method that may be implemented in connection with the system of FIG. 1 for use in binding parties, between pre-authorization and authorization, through network transactions; and

FIGS. 4A-4B are exemplary graphs related to binding of initiator parties and vendor parties, between pre-authorization and authorization, and confidence in the same.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Transactions for the purchase of certain products (e.g., goods, services, etc.) are pre-authorized in certain situations, prior to an amount being known or prior to specific authorization of the transaction. In various examples, an initiator party seeks pre-authorization for a transaction, for a given amount (or up to a given amount), and then a vendor party seeks authorization for the actual purchase transaction. This is common, for example, for travel purchases through a travel agency (e.g., Expedia, Travelocity, etc.) as an initiator party, where the vendor party is the airline, which then initiates actual purchase transactions for the airline tickets, for example. In this way, for similar transactions, discrepancies exist between the data included in the pre-authorization for the transactions and the authorization for the transactions. This is a potential avenue for the introduction of fraudulent transactions, where an improper party submits the authorization, after a legitimate pre-authorization is issued

Uniquely, the systems and methods herein permit the intelligent binding of parties between pre-authorizations and authorizations, based on network transactions between the parties, to provide assurance for authorization of the corresponding transactions.

In particular, a binding platform compiles historical data representative of pre-authorizations and authorizations, and compiles relationships, or pairs, between initiator parties and vendor parties. The pairs are based, for example, on the frequency or count of the transactions, which include the initiator/vendor parties (e.g., as paired combinations, etc.). In connection with subsequent transactions, the parties to the pre-authorizations and authorizations are compared to the compiled pairs of parties, and when a match is identified, the binding platform provides an indicator of some level of assurance that the transactions are indeed valid. In this manner, identified pairs of parties are established to provide insight into propriety of pre-authorized transactions, which may be leveraged by decision-makers associated with authorizing the transactions.

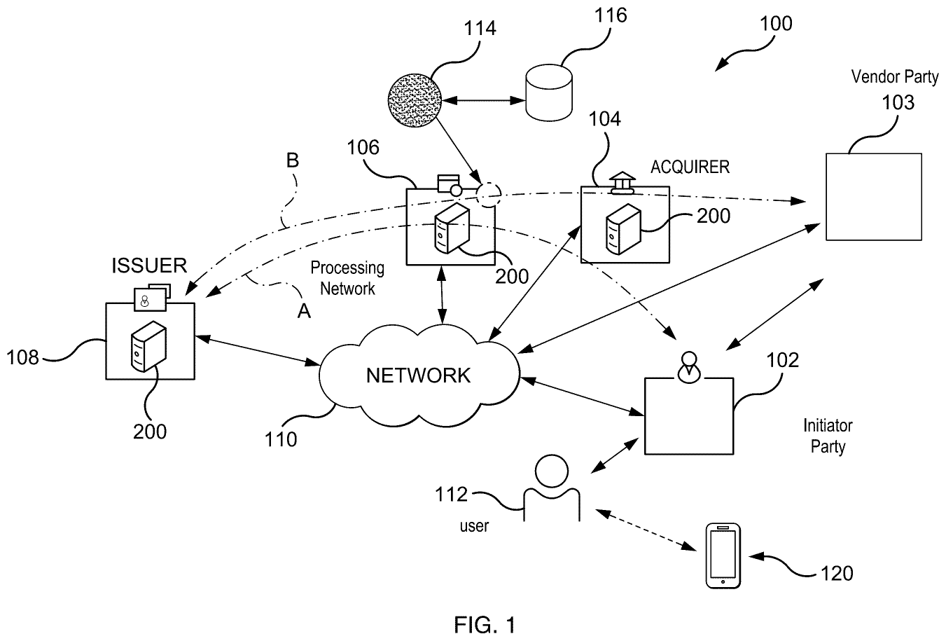

FIG. 1 illustrates an example system 100 in which one or more aspects of the present disclosure may be implemented. Although the system 100 is presented in one arrangement, other embodiments may include systems arranged otherwise depending, for example, on processing of transactions, parties involved in the transactions, manners in which transactions are initiated, privacy concerns, etc.

In the illustrated embodiment, the system 100 generally includes an initiator party 102, a vendor party 103, an acquirer 104, a processing network 106, and an issuer 108, each coupled to (and in communication with) a network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the processing network 106 to the acquirer 104 and the issuer 108 and, separately, the public Internet, which is accessible as desired to the first party 102, the processing network 106, the issuer 108, and one or more various users in the system 100 (e.g., user 112, etc.), etc.

The initiator party 102 is generally a purchase facilitator for one or more vendor parties, including the vendor party 103. The initiator party 102 is configured to interact with various vendor parties to offer the products of the various vendor parties to users for purchase. Often, the initiator party 102 is configured to host a virtual location (e.g., website, application, etc.), whereby users are permitted to access the virtual location from one or more different types of user devices (e.g., a communication device 120 of the user 112, etc.). The virtual location, in turn, is a marketplace, storefront, etc., for products (e.g., goods services, etc.) offered for sale by one or more of the vendors parties (e.g., based on product data therefrom, etc.). An example initiator party is a travel agency (e.g., EXPEDIA, TRAVELOCITY, etc.) or an e-commerce marketplace (e.g., ETSY, etc.), etc. In general, the initiator party 102 is configured to provide access, via the virtual location, to the products of the various vendor parties, for example, to view, browse, search, etc., among various products and to select one or more products to purchase.

In this example embodiment, the initiator party 102 is integrated with a secure remote commerce (SRC) service, whereby checkout for products, at the virtual location, is convenient, as described in more details below.

As part of a purchase, for example, by the user 112, the initiator party 102 is configured to initiate a pre-authorization of the transaction, as describe more below, and to return a checkout packet to the vendor party 103, which includes the details of the purchase, again, as explained more below.

In connection with the above, the vendor party 103 is generally a merchant associated with offering products for purchase to one or more users, including, for example, the user 112, independently or, more specific for the disclosure herein, through the initiator party 102. The vendor party 103 is configured to provide product data to be populated to the virtual location of the initiator party 102 (e.g., product descriptions, inventories, schedules, prices, etc.) (e.g., on-demand, at intervals, etc.) and to receive checkout packets from the initiator party 102. In response to the checkout packets from the initiator party 102, the vendor party 103 is configured to initiate authorization of the transaction based on the checkout packet, as explained more below. An example vendor party is an airline, offering airline tickets for sale through a travel agency (i.e., initiator party), while another vendor party is a craftsperson, offering furniture for sale through an e-commerce marketplace (i.e., initiator party).

It should be appreciated that any different combination of initiator parties and vendor parties may be included in other system embodiments, related to the sale of any products in which pre-authorization and authorization may be appropriate.

In the example embodiment illustrated ion FIG. 1, the acquirer 104 is a financial institution, such as, for example, a bank. The acquirer 104 is configured to issue an account to the vendor party 103. The account may be a payment account, or checking account, or other type of bank account, which is designated as the account into which the vendor party 103 is to receive funds from purchase transactions. Similarly, in this example embodiment, the issuer 108 is a financial institution, such as, for example, a bank. The issuer 108 is configured to issue accounts to users, including, for example, the user 112. The account may be a payment account or other type of bank account, from which the user 112 is permitted to pay funds to another party.

Each of the acquirer 104 and the issuer 108 are associated with the processing network 106. The processing network 106 may include, for example, the MASTERCARD, VISA, or DISCOVER processing network, etc. The processing network 106 is configured to facilitate messaging between the acquirer 104 and the issuer 108, generally, in connection with transactions between users and vendor parties. The messaging may include, for example, pre-authorization messages, authorization messages, clearing messages, etc., which may be consistent with the international standard for financial transaction card originated interchange messaging, ISO 8583, by the International Organization for Standards, or other suitable standard, etc.

As shown in FIG. 1, the user 112 is also associated with the communication device 120. The communication device 120 may include a smartphone, a tablet, a personal computer, a laptop, a desktop, a workstation, a PDA, etc., which is coupled to and/or is in communication with the issuer 108 (e.g., via an application associated with the issuer 108, via a web browser, or otherwise, etc.), for example, via the network 110.

As it relates to payment transactions, the system 100 includes a binding platform 114 and a data structure 116. The binding platform 114 is coupled to (and is in communication with) the data structure 116, and is specifically configured, by executable instructions, to perform one or more of the operations herein. While the binding platform 114 and the data structure 116 are illustrated as separate parts of the system 100 in FIG. 1, one or both may be incorporated into and/or located at one or more other parts of the system 100 (e.g., at the processing network 106 as indicated by the arrow in FIG. 1, or at the issuer 108, etc.). In addition, while the data structure 116 is illustrated as separate from the binding platform 114 in the system 100, in other embodiments the data structure 116 may be included, or integrated, in whole or in part, in the binding platform 114, etc.

Given the above, in one example transaction with the initiator party 102, the user 112 interacts with the virtual location of the initiator party 102, in order to identify a product for purchase and to present a credential associated with the user's payment account to fund the purchase. In connection therewith, it should be appreciated that the user 112 is enrolled for secure remote commerce, whereby the virtual location of the initiator party 102 is configured to interact with the processing network 106, in this embodiment, to retrieve a credential (e.g., a token, etc.) specific to the account issued by the issuer 108 to the user 112. This may be initiated, for example, by the user 112 selecting a click-to-pay option at the virtual location and presenting certain identifying information. Alternatively, the user 112 may present a payment credential (e.g., account number, etc.) directly to the initiator party 102.

Based thereon, the initiator party 102 is configured to generate a pre-authorization request for the transaction to be funded by the user's payment account and to communicate the pre-authorization request to the acquirer 104 (along path A in FIG. 1, in the pre-authorization domain). The pre-authorization request includes various data representative of the transaction, such as, for example, amount to be pre-authorized, name and/or identifier of the initiator party 102, URL of the initiator party 102, location data of the initiator party 102, merchant category code (MCC) for the initiator party 102, transaction ID, timestamp, acquirer data, user data (e.g., account data (e.g., token, primary account number (PAN), expiration date, CVC, etc.), etc.), etc.

In turn, the acquirer 104 is configured to communicate the pre-authorization request, along path A, to the processing network 106.

Upon receipt, the processing network 106 is configured to communicate the pre-authorization request to the issuer 108. In addition, the binding platform 114 identifies the communication as a pre-authorization request (e.g., based on content of the communication, etc.), and is configured to read the data included in the pre-authorization request (including, specifically, the data related to the initiator party 102) and to record that data to the data structure 116. It should be appreciated that in one or more embodiments, the binding platform 114 may be further configured to encode or hash the pre-authorization data prior to being stored in the data structure 116. Specifically, for example, the platform 114 may be configured to hash, for example, via the SHA256 hashing function, the pre-authorization data and/or encode the data based on a base64 scheme, etc., prior to storing the same in the data structure 116.

Separately, in response to the pre-authorization request, the issuer 108 is configured to assess the pre-authorization request and to determine whether, or not, to pre-authorize the transaction. The determination may be based on, for example, available credit for the account of the user 112, standing of the account, fraud scoring, or other data related to the account, the user 112, or the initiator party 102, etc. The issuer 108 is configured to compile a pre-authorization response, which indicates whether, or not, the transaction is pre-authorized and to communicate the pre-authorization response to the processing network 106. The processing network 106, in turn, is configured to communicate the pre-authorization response to the initiator party 102, via the acquirer 104. In addition, the binding platform 114 may be configured to supplement the data in the data structure 116 based on data included in the pre-authorization response, etc.

When the transaction is pre-authorized, the initiator party 102 is configured to compile a checkout packet specific to the transaction (e.g., including product details, account credential, timestamp, etc.). In response to the checkout packet, within some interval of the pre-authorization, the vendor party 103 is configured to generate an authorization request and to communicate the authorization request to the acquirer 104 (along path B in FIG. 1, in the authorization domain). The authorization request includes various details of the transaction, such as, for example, final amount of the transaction to be paid from the account of the user 112, name and/or identifier of the vendor party 103, URL and location data of the vendor party 103, MCC for the vendor party 103, transaction ID, acquirer data, timestep, account credential, user data, etc.

In turn the acquirer 104 is configured to communicate the authorization request, along path B, to the processing network 106.

Upon receipt, the processing network 106 is configured to communicate the authorization request to the issuer 108. In addition, the binding platform 114 is configured to read the data included in the authorization request (including, specifically, the data related to the initiator party 102 (e.g., name, URL, location data (e.g., address, etc.), etc.) (e.g., as included in data element (DE) 42, etc.)) and to record that data to the data structure 116. The binding platform 114 may be further configured to encode and/or hash the authorization data in a manner consistent with the encoding/hashing of the pre-authorization data, if applied above.

In response to the authorization message, the issuer 108 is configured to assess the authorization request and to determine whether, or not, to authorize the transaction. The determination may be based, at least in part, on the pre-authorization of the transaction. The issuer 108 is configured to compile an authorization response, which indicates whether, or not, the transaction is authorized and to communicate the authorization response to the processing network 106. The processing network 106, in turn, is configured to communicate the authorization response to the initiator party 102, via the acquirer 104. In addition, the binding platform 114 may be configured to supplement the data in the data structure 116 based on data included in the authorization response, etc.

When the transaction is authorized, the vendor party 103 is configured to proceed to complete the transaction and to deliver the product(s) to the user 112.

It should be appreciated that, while the binding platform 114 is configured to read and store data from the pre-authorization request and the authorization request in the above, the platform 114 may be configured, in other embodiments, to read and to store data from the pre-authorization response and/or the authorization response, or combinations of requests and/or responses.

The above is repeated hundreds, thousands, or millions, etc., of times for various users, initiator parties, vendor parties, etc. As a consequence, over time, the binding platform 114 is configured to compile hundreds, thousands, millions, etc., records including the pre-authorizations and authorizations for various transactions.

In this example embodiment, the binding platform 114 is further configured to match the initiator parties and the vendor parties, from the records, and where there is no match between the parties, to count a number of transactions (or assess the frequency of transactions) for unique ones of the initiator party/vendor party pairs. That is, in this example embodiment, the binding platform 114 is configured to initially match the account credential between the pre-authorization request and the authorization request to ensure the transactions are directed to the same account. Next, the binding platform 114 may be configured to further match data from the requests, including, for example, dates and times, types of transactions, card programs, etc., to further confirm the link between the pre-authorization and authorization requests. Next, the platform 114 is configured to match the initiator party 102 and the vendor party 103. When there is a match (e.g., either exact or a sufficient percentage of match, etc.), the first party is confirmed, i.e., the same between pre-authorization and authorization, whereby no pair is compiled, or needed.

However, when there is no match, the binding platform 114 is configured to match the initiator party 102 and the vendor party 103, as a pair, to other parties from other transactions (e.g., based on name, URL, location, etc.). And, when the initiator/vendor pair matches other transactions, the binding platform 114 is configured to identify the pairs and to count the number of transactions in which the pair is present. The count includes the number of transactions, which include the same initiator party 102 and the same vendor party 103. Table 1 illustrates multiple example pairs in historical transactions between initiator parties and vendor parties, in requests, and respective counts of the transactions.

TABLE 1

| Pre-Authorization | Authorization | Count |
|---|---|---|
| ABC Travel Agency | XZY Airline | 348 |
| www.ABC.travelagency.website | www.XYZairline.website | |
| City Town, NY | Townville, MO | |
| HIJ Travel Agency | XZY Airline | 221 |
| www.HIJ.travelagency.website | www.XYZairline.website | |
| Metro, NY | Townville, MO | |
| e-Commerce Shopper | Crafts Good Furniture | 34 |
| www.e-commerce.shopper.website | Jamestown, MO | |
| Millville, NJ | | |
| . . . | . . . | . . . |

As should be appreciated, in various embodiments, where numerous initiator parties and vendor parties are present, there will be numerous different pairs identified and associated with counts. It should be further appreciated that the binding platform 114 may be configured to maintain the counts over time, at one or more regular or irregular intervals, in real time, etc., at least for certain ones of the initiator/vendor pairs, etc. It should also be appreciated that beyond counts, the binding platform 114 may be configured to rely on frequencies, etc., or also, chargeback instances for either the initiator parties or vendor parties, etc., in permitted the pair to be bound, or not, etc.

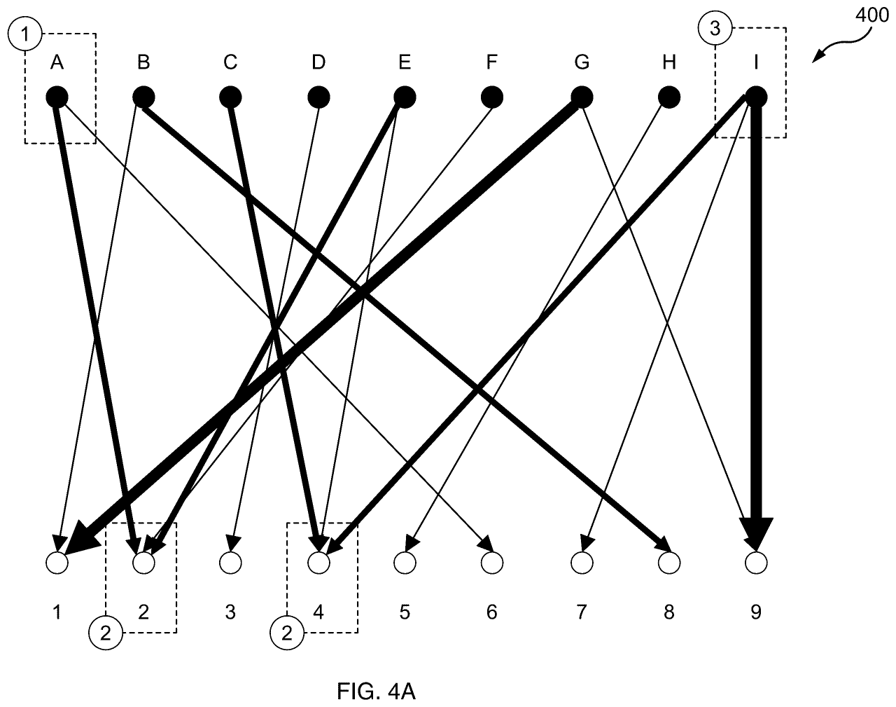

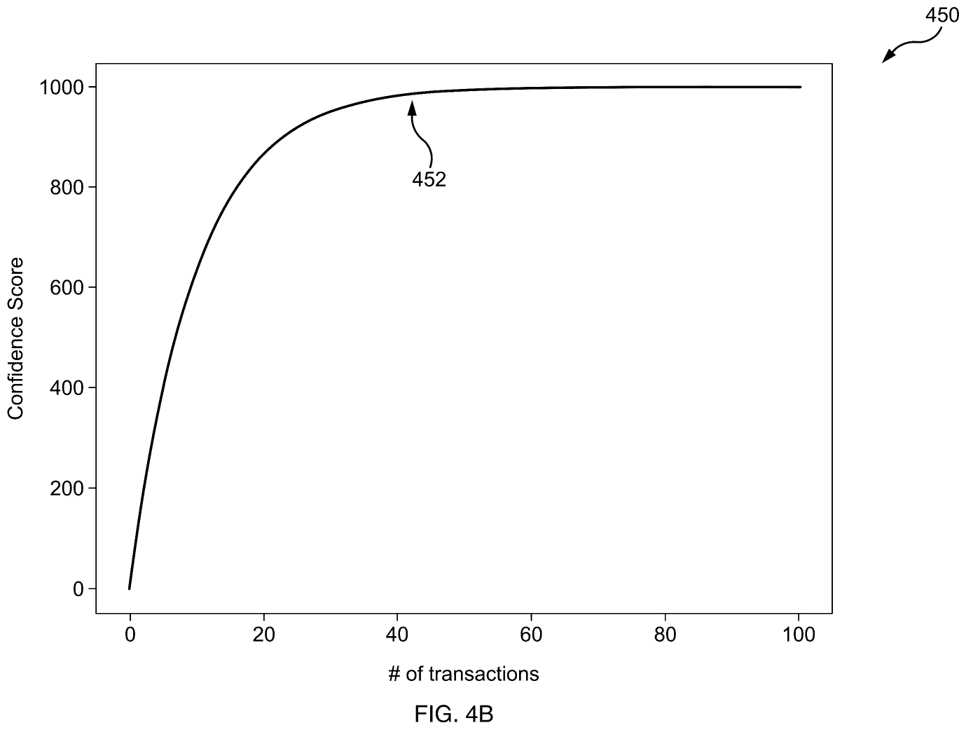

In this way, the binding platform 114 is configured to generate bound pairs of initiator parties and vendor parties, which may be referred to as a training mode of the binding platform 114 (which may further rely on a graphical representation of the transaction, as explained below with reference to FIG. 4, for example). That is, the binding platform 114 may be configured to determine whether a count for a given pair satisfies a threshold (e.g., exceeds forty transactions, exceeds 100 transactions, etc.) (e.g., potentially, subject to a threshold number of chargebacks, etc.), and then to determine the pair to be bound when the count for that pairs does satisfy the threshold. The binding platform 114 is configured to designate the pairs as bound, in the data structure 116.

Thereafter, consistent with the above description, the binding platform 114 is configured to receive the authorization request for a transaction, following pre-authorization of the transaction.

Initially, the binding platform 114 is configured to match the authorization request to a pre-authorization request in the data structure 116, based, at least, on the credential included in the authorization request and the timestamp. The binding platform 114 is then configured to determine whether the initiator party 102 is the same as the vendor party 103. In response to the parties being different, the binding platform 114 is configured to look up the initiator party 102 from the pre-authorization request from the data structure 116 and combine the initiator party 102 with the vendor party 103 from the authorization request to form an initiator/vendor pair. The binding platform 114 then is configured to confirm that the pair, from two different domains, i.e., authentication (or pre-authorization) and authorization, is indeed bound. This may be based on the above, where the count of previous transactions including the initiator/vendor pair is above a defined threshold. The confirmation may further be based on scoring of the pair, relative to the bound pairs, where the score is indicative of a confidence that the initiator/vendor pair is indeed proper. Based on the prior binding, in this example, the platform 114 is configured to determine that the initiator/vendor pair is valid and to append an indicator to the authorization request. The indicator may include, for example, a confidence score indicative of the confidence that the initiator party 102 and the vendor party 103, despite not being the same, are a valid pair of first parties. The confidence may be based on the number of prior transactions, weighted or not, etc.

It should be appreciated that an indicator may also be appended to the authorization request when the initiator party and the vendor party are the same (whereby the indicator is indicative of the same), or when the initiator party and the vendor party are not the same and also not included in a bound pair at the binding platform 114 (whereby the indicator is indicative of a warning, flag, exception, or notice to potentially investigate in connection with authorization, etc.). It should be further appreciated that other indicators may be appended to the authorization request based on the matching described herein.

Regardless of the type of the indicator, the processing network 106 is then configured to communicate the authorization request, with the appended indicator, to the issuer 108 consistent with the description above.

Consequently, the issuer 108 is configured to consider the indicator appended to the authorization request in connection with determining whether or not to authorize the transaction.

While one initiator party 102, one vendor party 103, one acquirer 104, one processing network 106, one issuer 108, one user 112, and one communication device 120 are included in the system 100 illustrated in FIG. 1, it should be appreciated that any number of these entities, devices, and/or persons (and their associated components) may be included in the system 100, or may be included as a part of systems in other embodiments, consistent with the present disclosure.

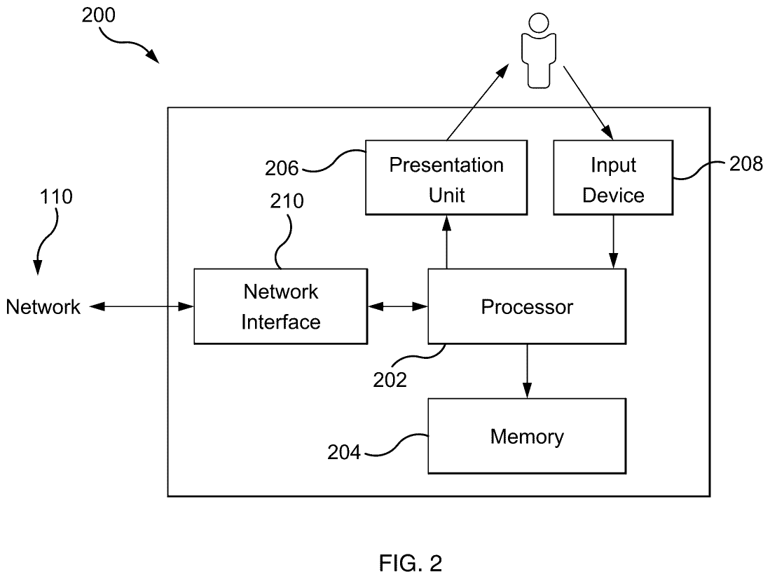

FIG. 2 illustrates an example computing device 200 that can be used in the system 100. The computing device 200 may include, for example, one or more servers, workstations, personal computers, laptops, tablets, smartphones, PDAs, POS devices, etc. In addition, the computing device 200 may include a single computing device, or it may include multiple computing devices located in close proximity or distributed over a geographic region, so long as the computing devices are specifically configured to function as described herein. In particular, in the example system 100 of FIG. 1, each of the initiator party 102, the vendor party 103, the acquirer 104, the processing network 106, and the issuer 108 are illustrated as including, or being implemented in, computing device 200, coupled to the network 110. In addition, the user's communication device 120 may be considered a computing device consistent with computing device 200. What's more, the platform and the data structure 116 may include and/or be implemented in at least one computing device consistent with the computing device 200.

That said, however, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, pairs (e.g., bindings, etc.), and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein (e.g., one or more operations of method 300, etc.), such that the memory 204 is a physical, tangible, and non-transitory computer readable storage media. Such instructions often improve the efficiencies and/or performance of the processor 202 that is performing one or more of the various operations herein whereby, in connection with such performance, the computing device 200 may be transformed into a special-purpose computing device for managing network traffic and related network transactions (e.g., binding parties as part of such network traffic, etc.). It should be appreciated that the memory 204 may include a variety of different memories, each implemented in one or more of the functions or processes described herein.

In addition in the example embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., confirmation of installment details, etc.), either visually or audibly, to a user of the computing device 200, for example, the user 112, users associated with other parts of the system 100, etc. Various interfaces (e.g., as defined by network-based applications, webpages, short message service (SMS) messages, emails, etc.) may also be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

The computing device 200 also includes an input device 208 that receives inputs from the user of the computing device 200 (i.e., user inputs) such as, for example, reading account numbers, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), a mobile network adapter, or other device capable of communicating to/with one or more different networks, including the network 110. Further, in some example embodiments, the computing device 200 may include the processor 202 and one or more network interfaces (including the network interface 210) incorporated into or with the processor 202.

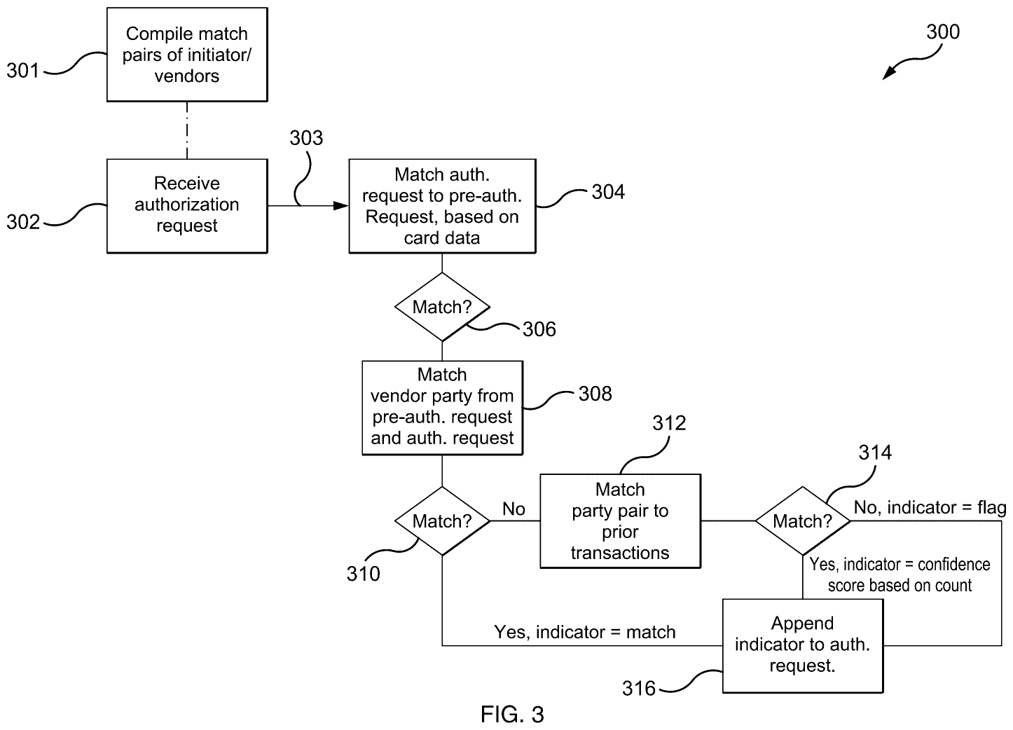

FIG. 3 illustrates an example method 300 for use in binding parties through and/or based on network transactions. The example method 300 is described as implemented in the system 100 with reference made to the platform 114 and the data structure 116, and further with reference to computing device 200. However, it should be understood that the method 300 is not limited to this configuration of the system 100, as the method 300 may be implemented, at least in part, in other parts of the system 100, or in multiple other computing devices or systems. As such, the methods herein should not be understood to be limited to the example system 100 or the example computing device 200, and likewise, the systems and the computing devices herein should not be understood to be limited to the example method 300.

At the outset in the method 300, the platform 114 compiles, at 301, match pairs of initiators/vendors. In particular, the platform 114 captures preauthorization requests and authorization requests and stores the requests in the data structure 116. The platform 114 may store only a portion of the data included in the requests, including, specifically, the name/identifier, the URL, and the location of the initiator party from the pre-authorization request and the name/identifier, the URL, and the location of the vendor party from the authorization request. Other data such as, for example, card data, the time and date, merchant category, program type, account type, transaction type, etc. may also be stored in the data structure 116.

In connection with storing the data, optionally, the platform 114 may encode and/or hash the data via any suitable technique. For example, to ensure security of the card data, the platform 114 may hash the card data, via a SHA256 hashing function, to secure the data prior to storing the data in the data structure 116. In other examples, certain data may be encoded to either secure the data or to facilitate matching of the data, as described below.

As authorization requests are received, or at one or more intervals, the platform 114 builds a graphical representation of the initiator and vendor parties involved in the transactions. In particular, for example, the platform 114 links the pre-authorization requests and the authorization requests, via common card data and potentially, time, date, type, etc. included therein. The platform 114 then compares the initiator and/or vendor parties from the linked pre-authorization requests and authorization requests.

When there is no match, the platform 114 creates a node for each vendor party and each initiator party. The nodes for the initiator parties are based on the merchant specific data from the pre-authorization requests, and the nodes for the vendor parties are based on the merchant specific data from the authorization requests. An example graphical representation 400 is illustrated in FIG. 4A, where multiple nodes along the top are representative of multiple different initiator parties designated A-I and multiple nodes along the bottom are representative of multiple different vendor parties designated 1-9. Each of the edges between the nodes (as represented by arrows in FIG. 4A) is an indicator of at least one transaction, in which the initiator party is represented by the node at one end of the edge and the vendor party is represented by the node at the other end of the edge.

It should be appreciated that each pair of nodes connected by an edge forms an initiator/vendor pair.

The platform 114 counts the number of transactions, which involve the unique initiator/vendor pair and adapts the thickness of the edge in FIG. 4A to be representative of the count. As such, the pairs G-1 and I-9 have a higher account than pairs A-2 and E-4, for example.

It should be understood from the graphical representation 400 that certain initiator parties and or vendor parties may be included in different pairs.

Based on the above, the platform 114 may recognize each of the pairs indicated in the graphical representation, or only those pairs having a threshold number of transactions, and compile the pairs of initiators/vendors.

The compiling of match pairs, by the platform 114, continues as additional pre-authorization requests are matched to authorization requests, at one or more intervals, or as authorization requests are received (e.g., in real time, etc.). In this way, initiator parties are bound to vendor parties, as a pair, based on a count of pre-authorization/authorization requests therebetween. It should be appreciated that the platform 114 may employ, for example, weighted averaging of the count of the transactions, using exponential smoothing, to account for more recent transactions in compilating the graphical representation, or binding pairs based thereon.

At 302, the platform 114 receives an authorization request for a transaction, via the processing network 106, from the acquirer 104. The authorization request includes card data specific to the account designated to fund the transaction and merchant specific data, etc.

Optionally, at 303, the platform 114 encodes and or hashes the data from the authorization requests, in whole or in part, consistent with any encoding and/or hashing of the data stored in the data structure 116. At 304, the platform 114 matches the data from the authorization request to a pre-authorization request, based on card data (and potentially, time and date of the same). This may include searching for a hashed card number from the authorization request, based on a time and date, in the data structure 116.

The platform 114 determines, at 306, whether there is a match of the authorization request to a pre-authorization request in the data structure 116.

When there is a match, the platform 114 matches, at 308, the vendor party from the pre-authorization request to the vendor party from the authorization request.

The platform 114 determines, at 310, whether there is a match between the vendor parties. When there is a match, the platform 114 may append an indicator to the authorization request, which may be a response code indicative of the match therebetween. In this manner, a cross-domain (i.e., between authentication (or pre-authorization) and authorization) matching is indicated in the authorization request.

When there is no match between the vendor parties, the platform 114 matches, at 312, the initiator/vendor pair from the authorization request with the compiled initiator/vendor pairs (from step 301) (e.g., from the graphical representation 400, etc.).

The platform 114 determines, at 314, whether there is a match of the initiator/vendor pair in the compiled initiator/vendor pairs. When there is a match, the platform 114 appends, at 316, an indicator to the authorization request (e.g., modifies a data element of the authorization request to include the indictor, etc.) and forwards the authorization request on to the issuer 108, whereby the issuer 108 is permitted to rely on (and/or account for) the indicator in responding to the authorization request. The indicator may include, for example, a confidence score indicator of a confidence that the initiator/vendor pair is indeed proper or legitimate. For example, historical data may be assessed, whereby a prior number of authentication and authorization transactions (e.g., with no chargebacks, etc.) for the initiator/vendor pair is indicative of a confidence. That is, for example, as shown in FIG. 4B, a graph 450 may be generated based on the historical data and a confidence curve 452 may be defined in the graph 450, having a scale from 0 to 1000 based on the historical data. As shown, for example, the confidence may be about 500 for ten prior matches for an initiator/vendor pair, or about 780 for twenty prior matches of the initiator/vendor pair, etc. It should be appreciated that other confidence graphs, curves, or scales, etc., and also other techniques for determining confidence associated with the pairs, may be employed in other embodiments. It should be further understood that where the confidence score with ranges that vary from 0 to 1000, the score may, optionally, be normalized to different scales, as necessary, to prompt interpretation or understanding of the indicator, etc.

And, further, as shown in FIG. 3, when platform 114 determines, at 114, that there is no match of the initiator/vendor pair in the compiled initiator/vendor pairs, the platform 114 appends an indicator, at 316, to the authorization request. The indicator, here, is indicative of, potentially, no match, a warning, unusual activity, or a not established pair, etc., whereby the issuer 108 may understand further scrutiny of the transaction may be warranted. It should be appreciated that when there is no match at step 314, the platform 114 may, alternatively, not append an indicator to the authorization request, whereby no indicator of a match (or a match of a pair), and/or no indicator of a confidence score is included.

Finally, after the indicator, as appropriate, is appended, or not, the authorization request is forwarded, by the processing network 106, along to the issuer 108, which, in turn, decides to authorize, or decline the transaction, potentially based on the indicator appended thereto, or potentially, the absence of the indicator.

In view of the above, the systems and methods herein provide for cross-domain assurance in connection with pre-authorized transactions. By providing cross-domain assurance, between the authentication or pre-authorization domain and the authorization domain, the binding platform enables the processing network to expand its functionality and to do something it could not do before. In this way, the receipt of the authorization request with an indicator of an initiator/vendor pair confidence, or mere indicator, is instructed as to the historical relationship or affiliation of the parties of the pair and/or the confidence that the pair is indeed proper.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and without limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving an authorization request for a transaction to an account, the authorization request including data specific to a vendor party; (b) matching the authorization request to a pre-authorization request, the pre-authorization request including an initiator party; (c) matching the initiator party and the vendor party, as a pair, to one of multiple initiator/vendor party pairs in a data structure; (d) appending, to the authorization request, an indicator of the match between the initiator party and the vendor party, and the one of multiple initiator/vendor party pairs in the data structure; and/or (e) forwarding the authorization request with the indicator to an issuer associated with the account.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in connection with network transactions, the method comprising:
as part of a training mode, generating, by a platform computing device, bound pairs of initiator parties and vendor parties, based on historical transaction data, each bound pair including one of the initiator parties and one of the vendor parties, the initiator parties specific to pre-authorization requests included in the historical transaction data and the vendor parties specific to authorization requests included in the historical transaction data; and
store the bound pairs in a data structure; and then
receiving, by the platform computing device, an authorization request for a transaction to an account, the authorization request including data specific to a first vendor party;
matching, by the platform computing device, the authorization request to a pre-authorization request, the pre-authorization request including a first initiator party;
matching, by the platform computing device, the first initiator party and the first vendor party, as a pair, to one of the bound pairs of initiator parties and vendor parties in the data structure;
appending, by the platform computing device, to the authorization request, an indicator of the match between the first initiator party and the first vendor party, and the one of the bound pairs in the data structure; and
forwarding the authorization request with the indicator to an issuer associated with the account.

2. The computer-implemented method of claim 1, wherein the authorization request includes card data; and
wherein matching the authorization request to the pre-authorization request includes matching the authorization request to the pre-authorization request based on the card data.

3. The computer-implemented method of claim 2, wherein the authorization request includes a time and date; and
wherein matching the authorization request to the pre-authorization request includes matching the authorization request to the pre-authorization request further based on the time and date of the authorization request.

4. (canceled)

5. The computer-implemented method of claim 1, wherein generating the bound pairs is based on counts of the pre-authorization requests and the authorization requests in the historical transaction data including initiator parties and vendor parties from said bound pairs.

6. The computer-implemented method of claim 5, wherein each of the bound pairs is generated based on the count of the pre-authorization requests and the authorization requests in the historical transaction data including the initiator party and the vendor party of said bound pair exceeding a threshold.

7. The computer-implemented method of claim 1, wherein the indicator includes a confidence score for the one of the bound pairs.

8. The computer-implemented method of claim 7, wherein the confidence score is based on a count of the pre-authorization requests and the authorization requests including the initiator party and the vendor party of the one of the bound pairs.

9. A system for use in connection with network transactions, the system comprising:
a processing network computing device having executable instructions in a non-transitory, computer readable memory, which when executed by a processor of the processing network computing device, cause the processor to:
as part of a training mode, generate bound pairs of initiator parties and vendor parties, based on historical transaction data, each bound pair including one of the initiator parties and one of the vendor parties, the initiator parties specific to pre-authorization requests included in the historical transaction data and the vendor parties specific to authorization requests included in the historical transaction data; and
store the bound pairs in a data structure; and then
in response to an authorization request for a transaction to an account, where the authorization request includes data specific to a first vendor party:
match the authorization request to a pre-authorization request, the pre-authorization request including a first initiator party:
match the first initiator party and the first vendor party, as a pair, to one of the bound pairs of initiator parties and vendor parties in the data structure;
append, to the authorization request, an indicator of the match between the first initiator party and the first vendor party, and the one of the bound pairs in the data structure; and
forward the authorization request with the indicator to an issuer associated with the account.

10. The system claim 9, wherein the authorization request includes card data; and wherein the executable instructions, when executed by the processor, cause the processor to match the authorization request to the pre-authorization request based on the card data.

11. The system of claim 10, wherein the authorization request includes a time and date; and
wherein the executable instructions, when executed by the processor, cause the processor to match the authorization request to the pre-authorization request based on the time and date of the authorization request.

12. (canceled)

13. The system of claim 9, wherein the executable instructions, when executed by the processor, further cause the processor to:
generate the bound pairs based on counts of the pre-authorization requests and the authorization requests in the historical transaction data including initiator parties and vendor parties from said bound pairs.

14. The system of claim 13, wherein each of bound pairs is generated based on the count of the pre-authorization requests and the authorization requests in the historical transaction data including the initiator party and the vendor party of said bound pair exceeding a threshold.

15. The system of claim 9, wherein the indicator includes a confidence score for the one of the bound pairs.

16. The system of claim 15, wherein the confidence score is based on a count of the pre-authorization requests and the authorization requests in the historical transaction data including the initiator party and the vendor party of the one of the bound pairs.

17. A non-transitory computer-readable storage medium comprising executable instructions, which when executed by at least one processor, cause the at least one processor to:
as part of a training mode, generate bound pairs of initiator parties and vendor parties, based on historical transaction data, each bound pair including one of the initiator parties and one of the vendor parties, the initiator parties specific to pre-authorization requests included in the historical transaction data and the vendor parties specific to authorization requests included in the historical transaction data; and
store the bound pairs in a data structure; and then
receive an authorization request for a transaction to an account, the authorization request including data specific to a first vendor party;
match the authorization request to a pre-authorization request, the pre-authorization request including a first initiator party;
match the first initiator party and the first vendor party, as a pair, to one of the bound pairs of initiator parties and vendor parties in the data structure;
append, to the authorization request, an indicator of the match between the first initiator party and the first vendor party, and the one of the bound pairs in the data structure; and
forward the authorization request with the indicator to an issuer associated with the account.

18. The non-transitory computer-readable storage medium of claim 17, wherein the executable instructions, when executed by the at least one processor, cause that at least one processor to generate the bound pairs based on counts of the pre-authorization requests and the authorization requests in the historical transaction data including initiator parties and vendor parties from said bound pairs.

19. The non-transitory computer-readable storage medium of claim 18, wherein each of the bound pairs is bound based on the count of the pre-authorization requests and the authorization requests in the historical transaction data including the initiator party and the vendor party of said bound pair exceeding a threshold.

20. The non-transitory computer-readable storage medium of claim 19, wherein the indicator includes a confidence score for the one of the bound pairs; and
wherein the confidence score is based on the count of the the pre-authorization requests and the authorization requests in the historical transaction data including the bound pair exceeding the threshold.
